(19) United States
(12) Patent Application Publication
(10) Pub. No.: US 2002/0102463 A1
(43) Pub. Date: Aug. 1, 2002

(54) Common carrier for a current collector

(76) Inventors: Joseph M. Probst, Williamsville, NY (US); Richard McCormick, East Aurora, NY (US)

Correspondence Address: David L. Principe, Hodgson Russ LLP, One M&T Plaza, Suite 2000, Buffalo, NY, 14203-2391, US

(21) Appl. No.: 09/773,036

(22) Filed: Jan. 31, 2001

(51) Int. Cl. H01M 4/72; B23P 13/00

(52) U.S. Cl. 429/241; 429/211; 29/2

(57) ABSTRACT

A common carrier that supports two or more current collectors in a horizontal planar array with geometric features providing datums for positioning tooling and other processes related to the fabrication of battery electrodes.

### FIELD OF INVENTION

The present invention generally relates to the art of electrochemical energy, and more particularly, to a common carrier for a current collector used in batteries and capacitors.

### BACKGROUND OF THE INVENTION

A current collector is a mechanical device typically used in electrochemical cells to form a part of the circuit and to interface with the chemical portion of the circuit. The current collector conducts electrical energy, supports active material which may serve as an electrode (anode or cathode), and enables even and uniform distribution of the active material throughout the current collector. The current collector is a key element of the electrochemical cell because the current collector affects the cell's running voltage. For batteries used in implantable medical devices such as defibrillators, optimal current collector design will maintain higher voltage when the cell is pulsed, thereby resulting in lower charge times for the implanted device. Finally, the configuration of the current collector has a significant impact on the requirements for the mechanical assembly process for the battery.

In order to form the grid or apertures on the current collector that receive the active material, the current collectors are manufactured by various methods including mechanical expansion, chemical etching, woven fabric, or perforation. State-of-the-art manufacturing techniques involve a planar structure in which numerous individual current collectors are attached to the raw material. Subsequent operations remove the individual current collectors from the raw material. These individual components removed from the planar structure comprise the current collectors that are assembled into batteries.

After the current collector is manufactured, an active material is applied to the current collector by means of mechanical pressing, chemical deposition or spray deposition. Depending on the nature of the active material, an anode or cathode electrode is formed. Typically, the active materials are applied to each individual current collector in a separate process.

Recent developments in battery technology have indicated that adding a thin layer of secondary material to the current collector prior to the application of active anode or cathode material has improved battery performance. The secondary material may consist of carbon, gold, or other compounds and is typically applied to the current collector using a spray deposition or plating process.

Applying secondary materials to individual current collectors is not practical for high volume production. Accordingly, there is a need for a common carrier to support multiple current collectors for application of the secondary materials to the current collectors in a high volume production environment.

### SUMMARY OF THE INVENTION

The present invention meets the above-described need by providing a common carrier for supporting several current collectors in a planar array for high volume processing.

In a preferred embodiment, the common carrier supports two or more current collectors in a horizontal planar array with geometric features providing datums for positioning tooling and other processes related to the fabrication of battery electrodes.

### BRIEF DESCRIPTION OF THE DRAWINGS

The invention is illustrated in the drawings in which like reference characters designate the same or similar parts throughout the figures of which:

FIG. 1 is a side elevational view of the common carrier of the present invention;

FIG. 2 is a side elevational view of the common carrier positioned in a tool;

FIG. 3 is a side elevational view of a current collector; and, FIG. 4 is a partial detailed view of the connection tab of the current collector of FIG. 1.

### DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

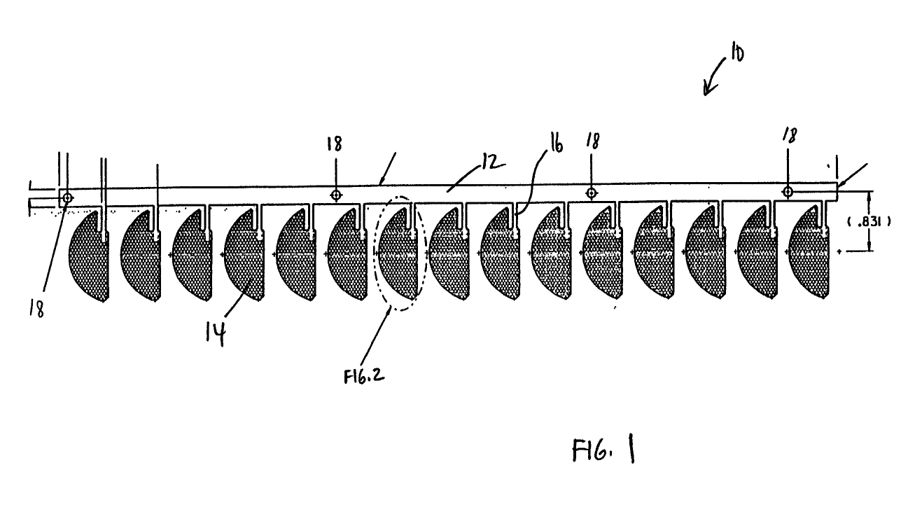

In FIG. 1, a common carrier 10 includes an elongate substantially planar support member 12. The support member 12 is constructed of the raw material for the screens and is preferably formed in the shape of a rectangle. A plurality of current collector screens 14 are integrally formed out of the raw material of the common carrier support member 12. The screens 14 attach to the support member 12 along the longitudinal axis of the support member 12. The screens 14 are preferably spaced equidistant from each other and connected to the support member 12 by external tabs 16 that extend from the screens 14 and are used to make an electrical connection in the finished prismatic cell, as disclosed in U.S. Pat. No. 5,750,286 issued to Paulot et al., which is assigned to the assignee of the present invention and which is incorporated herein by reference. The planar support member 12 is preferably provided with a plurality of holes 18 disposed along the longitudinal axis of the support member 12 and disposed at predetermined distances along the support member 12. The holes 18 serve as datum for orienting the common carrier of the present invention with respect to tooling. In this manner, the datum can be used to orient the screens with regard to tooling along the manufacturing process and for several steps of the process. Accordingly, the positioning of each screen relative to the datum is a constant that can be used for successive manufacturing steps. The holes 18 can be used for positioning the tooling either mechanically or electronically depending on the type of tooling or manufacturing equipment that is used for each step of the processing.

One of the steps of the manufacturing process for a current collector comprises the application of a thin layer of secondary material to the current collector prior to the application of active anode or cathode material. Recent developments in battery technology have indicated that adding this thin layer of secondary material to the current collector prior to the application of active anode or cathode material has improved battery performance. The secondary material may consist of carbon, gold, or other compounds and is typically applied to the current collector using a spray deposition or plating process.

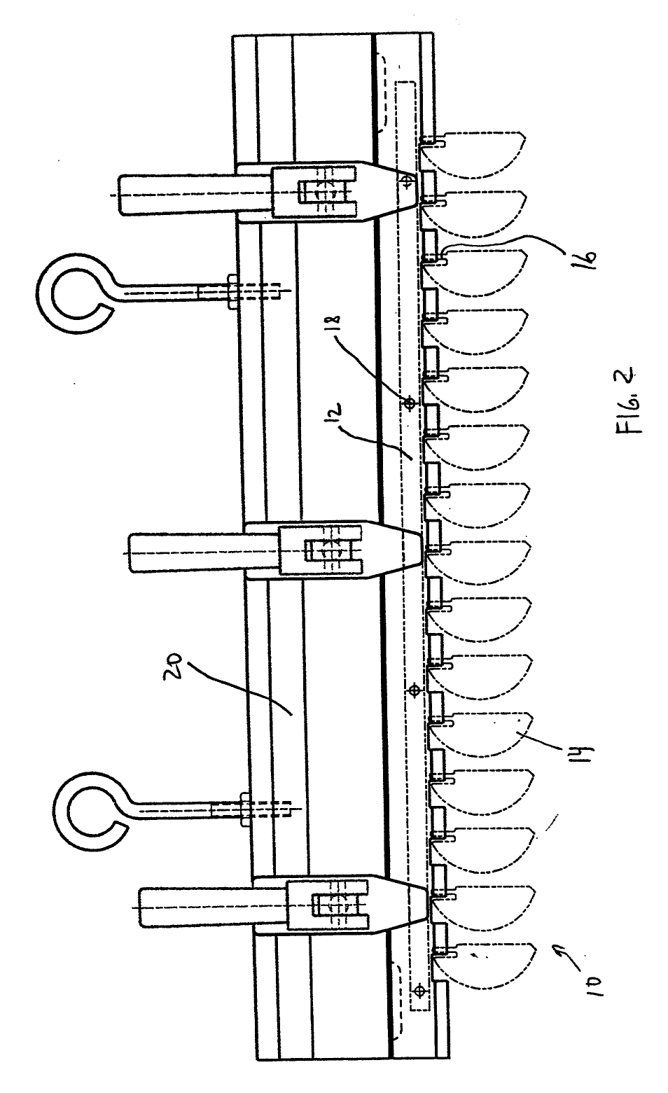

As shown in FIG. 2, the present invention allows for high volume application of secondary materials to the current collector screens. Several of the current collector screens can be treated at one time and the locatability of the common carrier with regard to the tooling 20 through the datum 18 provides for repeatability and consistent application to each common carrier. As shown, the current collectors are disposed such that the external tab 16 is substantially perpendicular to the longitudinal axis of the support member. The support member 12 is positioned on the tooling by the holes 18.

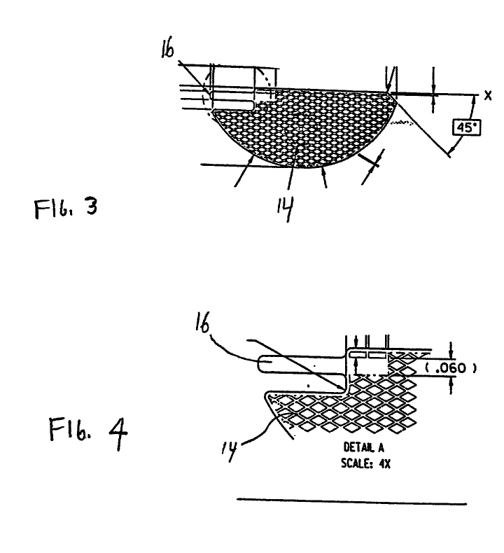

FIGS. 3-4 show a detailed view of the current collector screen which can be used for the cathode or anode materials depending on the orientation of the case (i.e., case negative or case positive). This particular design for a cathode current collector screen is disclosed in U.S. Pat. No. 575,286, which is assigned to the assignee of this application and incorporated herein by reference. Other types of current collector screens can also be used with the support member 12.

While the invention has been described in connection with certain preferred embodiments, it is not intended to limit the scope of the invention to the particular forms set forth, but, on the contrary, it is intended to cover such alternatives, modifications, and equivalents as may be included within the spirit and scope of the invention as defined by the appended claims.

What is claimed is:

1. A common carrier, comprising:
an elongate support member having a plurality of locating holes disposed thereon;
a plurality of current collector screens integrally formed with and extending from a portion of the support member.

2. The common carrier of claim 1, wherein the current collector screens are connected to the support member through an external tab extending from the current collector screen.

3. The common carrier of claim 1, wherein the common carrier screens are spaced apart equidistant from one another and are all oriented in the substantially same position relative to the support member.

4. The common carrier of claim 1, further comprising:
a secondary material disposed on the surface of the current collector screens.

5. A common carrier, comprising:
an elongate, planar support member having at least one datum;
a plurality of current collector screens formed integrally with the support member and extending from a portion of the support member;
wherein the support member is capable of being oriented with respect to a tool through the datum.

6. The common carrier of claim 5, wherein the current collector connects to the support member through an external tab.

7. The common carrier of claim 6, wherein the external tab connects at a substantially perpendicular orientation with the support member.

8. The common carrier of claim 6, further comprising:
a secondary material disposed on the surface of the current collector screens.

9. A method of making a current collector, comprising the steps of:
providing a common carrier, comprising:
an elongate support member having a plurality of locating holes disposed thereon;
a plurality of current collector screens integrally formed with and extending from a portion of the support member;
locating the common carrier on a tool by means of the datum;
applying a coating of secondary material to the current collector screens.
